(19) United States
(12) Patent Application Publication
(10) Pub. No.: US 2015/0175938 A1
(43) Pub. Date: Jun. 25, 2015

(54) COMPOSITION FOR CLEANING BEVERAGE CONTAINERS

(71) Applicants: Tom Sullivan, Huntington, CA (US); Scott Neiger, Costa Mesa, CA (US)

(72) Inventors: Tom Sullivan, Huntington, CA (US); Scott Neiger, Costa Mesa, CA (US)

(21) Appl. No.: 14/523,924

(22) Filed: Oct. 26, 2014

Related U.S. Application Data
(60) Provisional application No. 61/920,717, filed on Dec. 24, 2013.

(51) Int. Cl. C11D 3/18; C11D 1/74; C11D 3/32; B08B 3/08

(52) U.S. Cl. CPC C11D 3/185; B08B 3/08; C11D 1/74; C11D 3/32

(57) ABSTRACT

A composition for cleaning a beverage container is disclosed. The composition first comprises mixing predetermined amounts of D-Limonene with a surfactant wherein this mixture is then added to an amount of water and dissolved. The resulting dissolved mixture of these three ingredients is used to clean an empty rinsed out beverage container for removing odor from the beverage container for reuse.

### RELATED APPLICATIONS

This application claims benefit of priority to U.S. Provisional Patent Application No. 61/920,717 entitled “Composition for Cleaning Beverage Containers” filed Dec. 24, 2013, the aforementioned priority application being hereby incorporated by reference in its entirety.

### TECHNICAL FIELD

The invention relates to cleaning compositions and more particularly, the invention relates to a composition for cleaning beverage containers.

### BACKGROUND ART

Nutritional or protein shakes are often prepared in a beverage container such as a shaker. In this process a protein powder is typically placed in the shaker with a liquid, typically water or milk. Then, the container is shook until the protein powder is incorporated into the liquid. The preparation of nutritional shakes in shakers may result after use in a foul smelling shaker especially since in heat protein tends to rot.

Unfortunately, there is no efficient way to clean protein shakers after use to remove their odor. Accordingly, there exists a need for a simple quick and easy method of removing the odor from a protein shaker bottle when it becomes smelly and starts to stink. The present invention solves this problem and more in a unique and novel fashion.

### SUMMARY OF THE INVENTION

A composition for cleaning a beverage container is disclosed. The composition first comprises mixing predetermined amounts of D-Limonene with a surfactant wherein this mixture is then added to an amount of water and dissolved. The resulting dissolved mixture of these three ingredients is used to clean an empty rinsed out beverage container for removing odor from the beverage container for reuse.

In accordance with these and other objects, which will become apparent hereinafter, the instant invention will now be described with particular reference to the accompanying drawings.

### DESCRIPTION OF THE DRAWINGS

In the accompanying drawings:

FIG. 1 is a flowchart illustrating one method for using a composition in accordance with the present invention for cleaning a beverage container.

### DESCRIPTION OF EMBODIMENTS

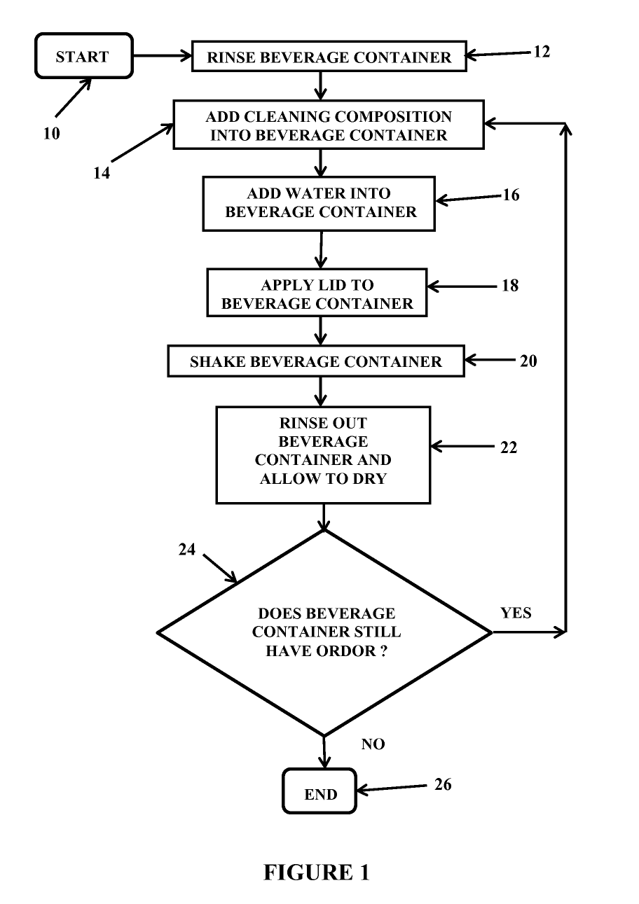

Embodiments of the invention are discussed below with reference to FIG. 1. However, those skilled in the art will readily appreciate that the detailed description given herein with respect to this FIGURE is for explanatory purposes as the invention extends beyond this limited embodiment. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiment described and shown. That is, there are numerous modifications and variations of the invention that are too numerous to be listed but that all fit within the scope of the invention.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

A practical embodiment of the present invention provides a solution that removes odor from beverage containers such as protein shakers. Shakers that are used to make protein shakes often become dirty and foul smelling. Many practical embodiments provide a powder that is added to water in a shaker to remove this odor. Some alternate embodiments may be implemented to clean other types of shakers which by way of example but not of limitation may be powdered drink mix shakers, cocktail shakers and shakers for various different types of nutritional shakes, etc.

Referring now to FIG. 1 there is shown a flowchart illustrating one method for using the composition in accordance with a preferred embodiment of the present invention. In this embodiment, the method starts 10 after a user uses a shaker or beverage container to make a protein shake or another type of shake. First, the user rinses the shaker or beverage container 12. Next, the user adds the cleaning composition to the shaker or beverage in step 14. In step 16, the user adds water to the shaker or beverage container. Alternatively, the user may reverse the order of steps 14 and 16 by adding water to the shaker then adding the cleansing composition to the shaker or beverage container. In step 18 and 20, the user secures the lid to the shaker or beverage container and shakes. The user empties the shaker or beverage container in step 22 and rinses the shaker or beverage container and allows it to dry. In the present embodiment, if the shaker or beverage container still has an odor in step 24, the user may return to step 14 to repeat the method. The method ends 26 when the odor is removed from the shaker or beverage container.

In accordance with the present invention, the cleaning composition is a mixture of D-Limonene with a surfactant. In one preferred embodiment the surfactant is polysorbate 20 wherein D-Limonene is mixed with polysorbate 20 and added to water with the following combination: 1 fl oz D-Limonene, 1 fl oz polysorbate 20 and 6 fl oz water that produces eight ounces of the cleaning composition. Those skilled in the art will appreciate that other quantities of the composition may be prepared as long as substantially the same proportions of D-Limonene, polysorbate 20, and water are used. Additionally, using the method described above the shaker or cleaning beverage is filled halfway with water wherein a teaspoon of this cleaning composition is then added. As described in the method above the shaker or container is then shook 15 seconds or longer and then emptied, rinsed out and allowed to dry.

In one preferred embodiment the surfactant is Cocamidopropyl Betaine wherein D-Limonene is mixed with Cocamidopropyl Betaine and added to water with the following combination in percentages: 12 percent in fl oz of D-Limonene, 5 percent in fl oz of Cocamidopropyl Betaine and 83 percent in fl oz of water that will totally produce eight ounces of the cleaning composition. Those skilled in the art will appreciate that other quantities of the composition may be prepared as long as substantially the same percentage proportions of D-Limonene, Cocamidopropyl Betaine, and water are used. Additionally, using the method described above the shaker or cleaning beverage is filled halfway with water wherein a teaspoon of this cleaning composition is then added. As described in the method above the shaker or container is then shook 15 seconds or longer and then emptied, rinsed out and allowed to dry.

In another preferred embodiment the mixture of D-Limonene and the surfactant, which by way of example and not of limitation may be either polysorbate 20 or Cocamidopropyl Betaine may be implemented as a powder placed in a packet. Dispensing a powder from packets is simple, fast and easy to use and generally leaves no watery soap aftertaste. Packets are also desirable if the user would like to use the powder outside of their home, for example, at the gym immediately after a workout or at work. Shakers that are cleaned by a powder are typically germ free, odor free and sanitary. Thoroughly cleaning a shaker typically enables the shaker to be used repeatedly and for an extended time so that a user generally does not waste shakers by discarding shakers that have a foul smell.

In some alternate embodiments, the composition may be implemented as a pre-mixed solution rather than a powder. Those skilled in the art will readily recognize, in light of and in accordance with the teachings of the present invention, that odor removing compositions in some alternate embodiments may be implemented in a multiplicity of suitable forms such as, but not limited to, packets, dissolving capsules, sprays, etc. Furthermore, it is contemplated that odor removing compositions in accordance with some alternate embodiments may be used to clean various different types of devices and containers including, blenders, glasses, reusable bottles, etc. and that the process of removing the odor from these items may vary from the method described above.

Having fully described at least one embodiment of the present invention, other equivalent or alternative methods of providing a composition for odor removal according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A composition for cleaning a beverage container, the composition comprising: a mixture of D-Limonene and polysorbate 20 for cleaning the beverage container wherein said mixture being configured to be dissolvable in water, said dissolved mixture being operable for substantially removing odor from the beverage container after use.

2. The composition according to claim 1, in which said mixture is 1 fluid ounces D-Limonene, 1 fluid ounces polysorbate 20.

3. The composition according to claim 1, in which said mixture is dissolved in 6 fluid ounces water.

4. The composition according to claim 1, in which said mixture comprises a powder.

5. The composition according to claim 1, in which said dissolved mixture further comprises substantially the same proportional amounts of D-Limonene, polysorbate 20 and water mixed together.

6. The composition according to claim 1, in which the container comprises a shaker being configured for mixing a protein shake.

7. The composition according to claim 1, in which a packet for containing said mixture of D-Limonene and polysorbate 20 is provided for cleaning one container.

8. A method for cleaning a beverage container comprising the steps of: combining a mixture of D-Limonene and polysorbate 20 and a quantity of water in the beverage container; shaking the dissolved mixture in the container; and rinsing out and allowing the beverage container to dry thereby removing odors from the beverage.

9. The method as recited in claim 8, further comprising the step of mixing 1 fluid ounces D-Limonene to 1 fluid ounces polysorbate 20 to 6 fluid ounces ounces of water and adding one fluid ounce of this composition to the beverage container.

10. The method as recited in claim 8, in which in which a packet for containing said mixture of D-Limonene and polysorbate 20 is provided for cleaning one container.

11. The method as recited in claim 8, in which the step of shaking comprises shaking the beverage container for 15 seconds or longer.

12. The method as recited in claim 8, in which the method is repeated if an odor still exists.

13. A composition for cleaning a beverage container, the composition comprising: a mixture of D-Limonene and Cocamidopropyl Betaine for cleaning the beverage container wherein said mixture being configured to be dissolvable in water, said dissolved mixture being operable for substantially removing odor from the beverage container after use.

14. The composition according to claim 13, in which said mixture is 12 percent in fluid ounces of D-Limonene and 5 percent in fluid ounces Cocamidopropyl Betaine.

15. The composition according to claim 13, in which said mixture is dissolved in 83 percent in fluid ounces of water.

16. The composition according to claim 13, in which said mixture comprises a powder.

17. The composition according to claim 13, in which said dissolved mixture further comprises substantially unequal amounts of D-Limonene, Cocamidopropyl Betaine and water mixed together.
